(19) United States
(12) Patent Application Publication
(10) Pub. No.: US 2023/0216339 A1
(43) Pub. Date: Jul. 6, 2023

(54) SYSTEMS AND METHODS FOR DIFFERENTIAL POWER GENERATION

(71) Applicants: Duke Energy Corporation, Charlotte, NC (US); A-PLUS Community Solutions, Inc., Roswell, GA (US)

(72) Inventors: Ron K. Wages, Waxhaw, NC (US); Larry J. Morrow, Nashville, GA (US)

(21) Appl. No.: 18/057,433

(22) Filed: Nov. 21, 2022

Related U.S. Application Data
(60) Provisional application No. 63/266,305, filed on Dec. 31, 2021.

(51) Int. Cl. H02J 13/00; H02J 3/38

(52) U.S. Cl. CPC H02J 13/00019; H02J 13/00002; H02J 13/00034; H02J 3/381; H02J 13/00017; H02J 2300/20

(57) ABSTRACT

Systems, apparatuses, methods, and computer program products are disclosed for differential power generation. An example method includes receiving, by a control system, telemetry data from a set of devices in an electrical grid and calculating, by the control system, an electrical load for the electrical grid based on the telemetry data. The example method further includes generating, by the control system, a set of power production metrics, identifying, by the control system and based on the calculated electrical load for the electrical grid and the set of power production metrics, an optimal allocation of power production from multiple sources of electricity that supply the electrical grid, and causing, by the control system and based on the optimal allocation of power production from the multiple sources of electricity, adjustment to power production from one or more of the multiple sources of electricity. Corresponding apparatuses and computer program products are also disclosed.

### CROSS REFERENCE TO RELATED APPLICATIONS

The present application claims the benefit of U.S. Provisional Application No. 63/266,305, filed Dec. 31, 2021, which is hereby incorporated by reference in its entirety.

### TECHNOLOGICAL FIELD

The present disclosure relates in general to the field of electrical power distribution, and more specifically, to systems for utilizing near-real-time data communications to enable adjustable power delivery to end-users from varying power generation facilities based on situational awareness of energy demand or other variable conditions.

### BACKGROUND

Modern power distribution grids include many generation and transmission resources used to provide power to different types of user loads. Generation and transmission resources may include generators, transmission lines, substations, transformers, etc.

FIG. 1 is a simplified block diagram illustrating an example electrical power distribution environment 100. Referring to FIG. 1, electric power may be generated at a power generation facility 110 for distribution to users 140A-140N that consume the generated electric power. Examples of power generation facilities 110 include facilities which generate electricity from fossil fuels (e.g., coal, petroleum, and/or natural gas), solar energy, geothermal energy, nuclear energy, potential energy (e.g., with a hydroelectric facility), wind energy, and/or chemical energy.

Once generated at the power generation facility 110, the electricity may be delivered to the users 140A-140N via a power distribution grid. The power grid may include, for example, power transmission lines 115 between the power generation facility 110 and one or more substations 120. The electricity may be further transmitted from a given substation 120 to one or more of users 140A-140N over electrical distribution circuits 130, also known as feeders. For example, the electrical distribution circuit 130 may provide electricity to any one of users 140A-140N via a connection between the electrical distribution circuit 130 and the location (e.g., house or building) of the user, such as, for example, at a power meter. The electrical distribution circuits 130 may include, for example, both overhead and underground power lines. Electrical distribution circuits 130 may include additional segmentation. For example, an electrical distribution circuit 130 may include one or more protective devices 135. Protective devices 135 may include, for example, switches, circuit breakers, and/or reclosers.

Legacy infrastructure relies upon bulk electric power production throughout a day, potentially overlaid with power generated from multiple sustainable sources. However, legacy power distribution infrastructure cannot detect minute-to-minute fluctuations in production of renewable energy or minute-to-minute fluctuations in power consumption by users. As such, legacy systems typically generate too much power from non-fluctuating sources to ensure sufficient production for the possible needs of the users. As a result, however, power generated from renewable sources may not actually offset power generated from other sources.

Therefore, conventional systems for generating and distributing electric power are inefficient in multiple dimensions. First, they generally produce more electric power than is actually needed throughout the day. And second, they generally are unable to effectively adjust to intra-day fluctuations in production capacity from variable power sources, demand from user, or other factors (e.g., production cost).

### BRIEF SUMMARY

It is known that electricity utilization will vary throughout the day and that fluctuations in production capacity from renewable sources and demand from users are common. Systems, apparatuses, methods, and computer program products are disclosed herein for differential power generation to avoid waste and to more efficiently utilize electric power generated by various sources.

An example method for differential power generation is disclosed herein. The example method includes receiving, by a control system, telemetry data from a set of devices in an electrical grid, calculating, by the control system, an electrical load for the electrical grid based on the telemetry data, and generating, by the control system, a set of power production metrics. The example method further includes identifying, by the control system and based on the calculated electrical load for the electrical grid and the set of power production metrics, an optimal allocation of power production from multiple sources of electricity that supply the electrical grid, and causing, by the control system and based on the optimal allocation of power production from the multiple sources of electricity, adjustment to power production from one or more of the multiple sources of electricity.

In one example embodiment, an apparatus is provided for differential power generation. The example apparatus includes a processor and a memory storing software instructions that, when executed by the processor, cause the apparatus to receive telemetry data from a set of devices in an electrical grid, calculate an electrical load for the electrical grid based on the telemetry data, and generate a set of power production metrics. The processor and a memory storing software instructions that, when executed by the processor, further cause the apparatus to identify, based on the calculated electrical load for the electrical grid and the set of power production metrics, an optimal allocation of power production from multiple sources of electricity that supply the electrical grid, and cause, based on the optimal allocation of power production from the multiple sources of electricity, adjustment to power production from one or more of the multiple sources of electricity.

In one example embodiment, a computer program product is provided for differential power generation. The computer program product includes at least one non-transitory computer-readable storage medium storing software instructions that, when executed by an apparatus, cause the apparatus to receive telemetry data from a set of devices in an electrical grid, calculate an electrical load for the electrical grid based on the telemetry data, and generate a set of power production metrics. The at least one non-transitory computer-readable storage medium storing software instructions that, when executed by an apparatus, further cause the apparatus to identify, based on the calculated electrical load for the electrical grid and the set of power production metrics, an optimal allocation of power production from multiple sources of electricity that supply the electrical grid, and cause, based on the optimal allocation of power production from the multiple sources of electricity, adjustment to power production from one or more of the multiple sources of electricity.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a simplified block diagram illustrating an example electrical power distribution environment.

FIG. 2 illustrates a simplified block diagram of an example electrical power distribution environment and corresponding fiber optic network, in accordance with some example embodiments described herein.

FIG. 3 illustrates a schematic block diagram of example circuitry embodying a device that may perform various operations in accordance with example embodiments described herein.

FIG. 4 illustrates an example flowchart for differential power generation, in accordance with some example embodiments described herein.

FIG. 5A illustrates an example graph showing electric power produced throughout a given day from a variety of sources using traditional methods of power generation.

FIGS. 5B-5C illustrate a close-up view of the graph shown in FIG. 5A.

FIG. 6A illustrates an example graph showing electric power produced throughout a given day from a variety of sources using example embodiments described herein for differential power generation.

FIGS. 6B-6C illustrate a close-up view of the graph shown in FIG. 6A.

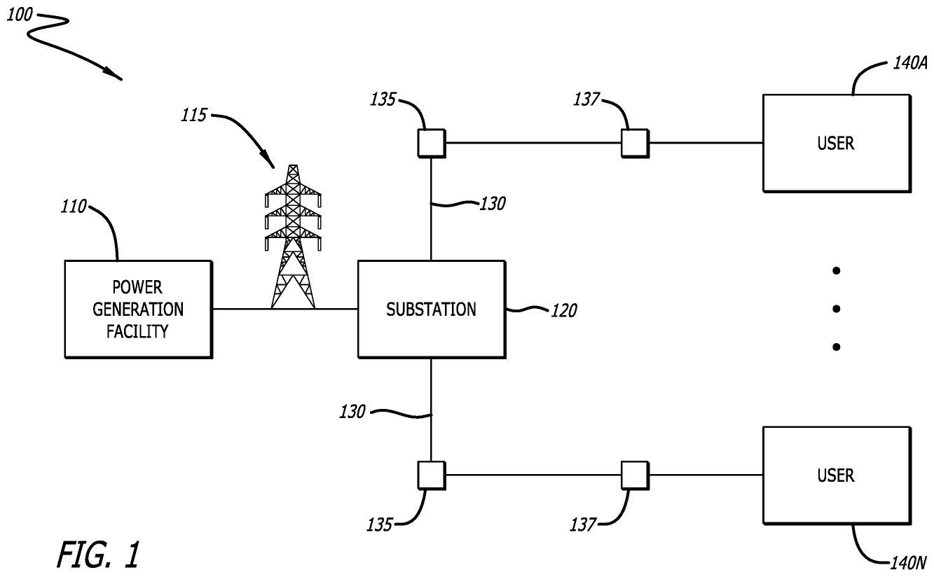

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

### Overview

As noted above, legacy infrastructure cannot detect minute-to-minute fluctuations in production of renewable energy or minute-to-minute fluctuations in power consumption by users. Therefore, conventional systems for generating and distributing electric power are inefficient in multiple dimensions. First, they generally produce more electric power than is actually needed throughout the day. And second, they generally are unable to effectively adjust to intra-day fluctuations in production capacity from variable power sources, demand from user, or other factors (e.g., production cost). Conventional systems produce excess power in to allow to accommodate power spikes and prevent power outages or shortages. However, the majority of this excess power is lost as current battery energy storage system (BESS) technology is limited and cannot accommodate storage of this excess energy. Furthermore, this excess power is often lost to the environment in a form of heat, thereby resulting in multiple energy inefficiencies.

These issues are growing in importance because microgrid deployment allows a new possibility to generate power that matches usage with sub-second response times. This allows for the standard baseload power margin to be substantially reduced and adds flexibility of generation sources to provide the safest, most reliable, cleanest, lowest cost power to customers in that second. Microgrid deployment is expected to be able to reduce the cost of power production due to transmission line losses and reduced loss from transformers by up to 20%.

To overcome existing power generation inefficiencies and take advantage of new opportunities offered by microgrid deployments, example embodiments described herein rely upon an enhanced electrical power distribution environment leveraging the use of a corresponding fiber optic network that permits near-real-time exchange of information between entities in the environment.

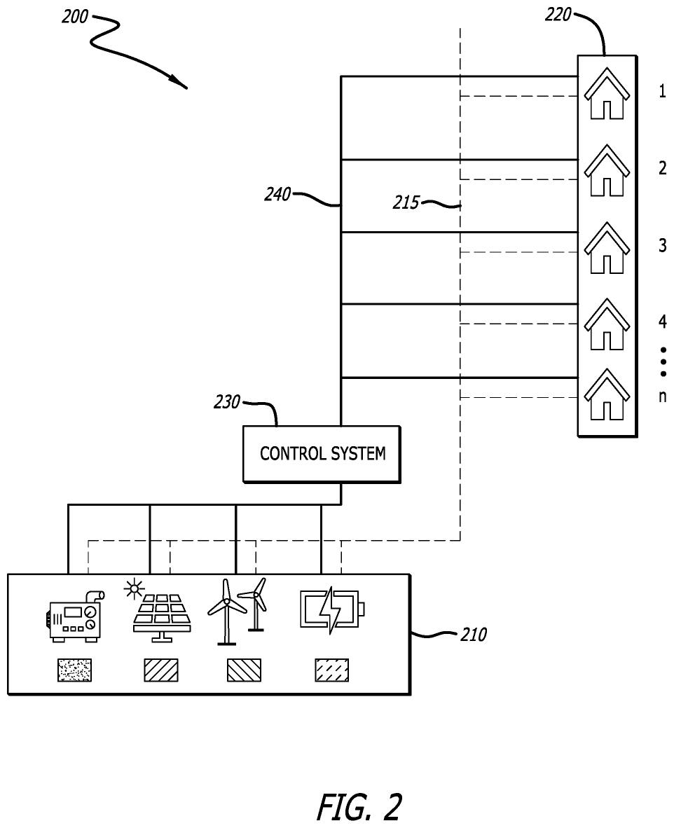

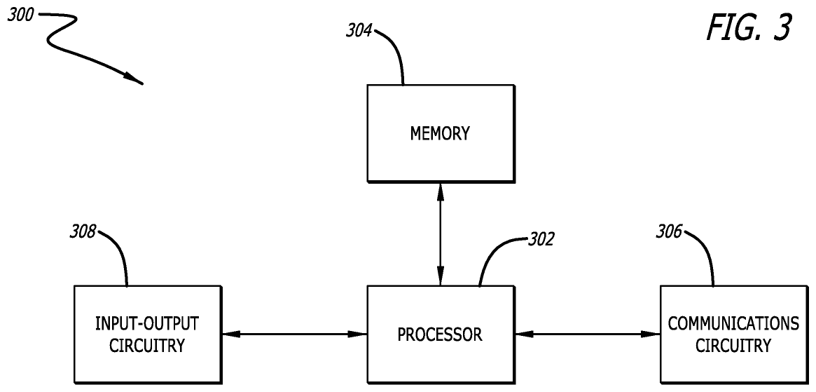

FIG. 2 illustrates a simplified block diagram of an example electrical power distribution environment 200 enhanced by a corresponding fiber optic network, in accordance with some example embodiments described herein. FIG. 2 illustrates a series of power generating facilities 210 (which may comprise facilities that generate electricity from fossil fuels, solar energy, geothermal energy, nuclear energy, potential energy (e.g., with a hydroelectric facility), wind energy, and/or chemical energy.) that may be provide power to a series of users 220 via a distribution network 215. While power generation facilitates 110 are traditionally located in fixed locations within an environment remote from heavily populated areas and connected to the rest of the environment via transmission lines, many renewable power generation facilitates (e.g., wind, solar, fuel-based generators, and battery enclaves) may be distributed throughout the environment. In addition, however, FIG. 2 illustrates a control system 230 that may exchange information with the power generating facilities 210 and the users 220 via a fiber optic network 240. As shown in FIG. 2, control system 230 may be positioned within the fiber optic network 240 such that it may communicate with multiple devices within the fiber optic network 240, including the power generating facilities 210 and the users 220. Various components of the control system 230 are described in greater detail below in connection with FIG. 3. The fiber optic network 240 may connect to just the endpoints in the electrical power distribution environment 200 or may connect to all entities (including transformers, switches, circuit breakers, reclosers, etc.) in the electrical power distribution environment 200.

The fiber optic network may comprise a passive optical network (PON) to reduce the number of fiber optic cables needed for connectivity and the number of active devices requiring electrical power, and may utilize wavelength-division multiplexing (e.g., coarse wavelength division multiplexing (CWDM) or dense wavelength division multiplexing (DWDM)) to permit bidirectional communications and/or a multiplication of capacity of the fiber optic network. Connection of the fiber optic network to the various entities in the electrical power distribution environment 200 enables near-real-time communication between any two entities in the environment with any other entity.

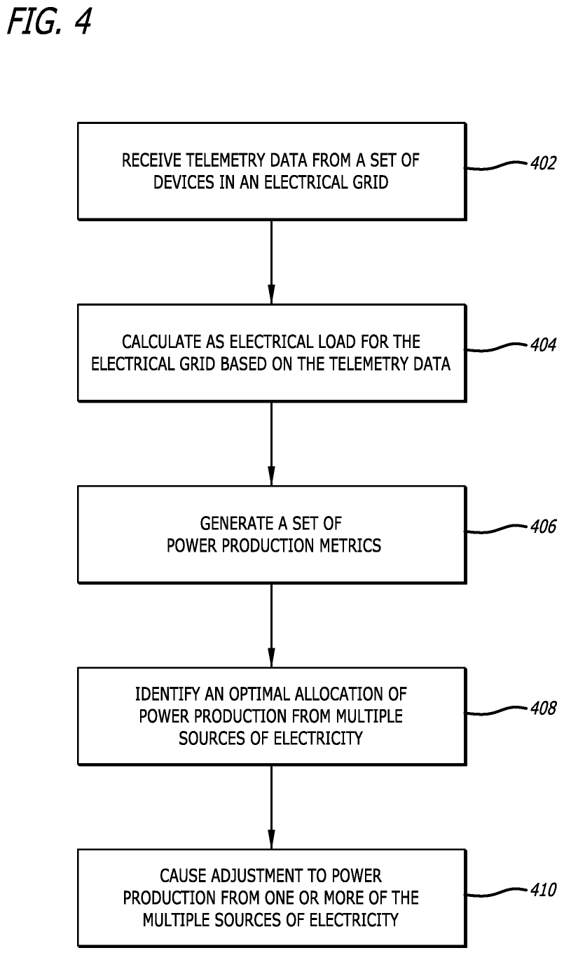

The control system 230 leverages the existence of the fiber optic network 240 to receive telemetry data (e.g., small data packets transmitted in sub-millisecond intervals) from various devices in the electrical power distribution environment 200. From this telemetry data, the control system may calculate an electrical load for the electrical grid in near-real-time. Similarly, the control system 230 may generate a set of power production metrics for the various power generating facilities 210 in the environment. Based on the calculated electrical load for the electrical grid and the set of power production metrics, the control system 230 may therefore identify an optimal allocation of power production from the power generating facilities 210. Finally, the control system 230 may cause adjustment to the power production from one or more of the power generating facilities to maximize any desired metric (e.g., reduce cost, maximize reliance on renewable facilities, or the like). Example implementations disclosed herein may therefore enable differential power generation to avoid waste and to more efficiently utilize electric power generated by various sources. More detail regarding this example functionality is described below in connection with FIG. 4.

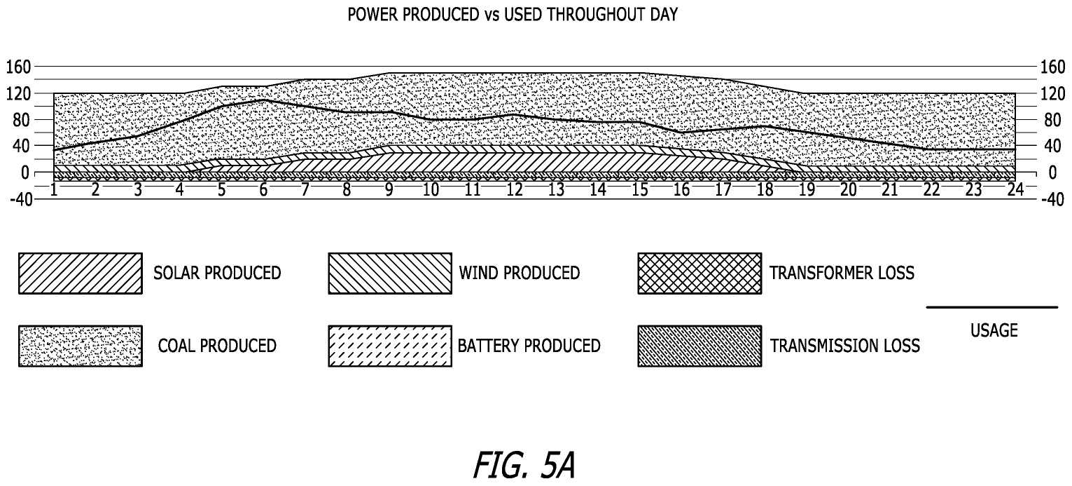

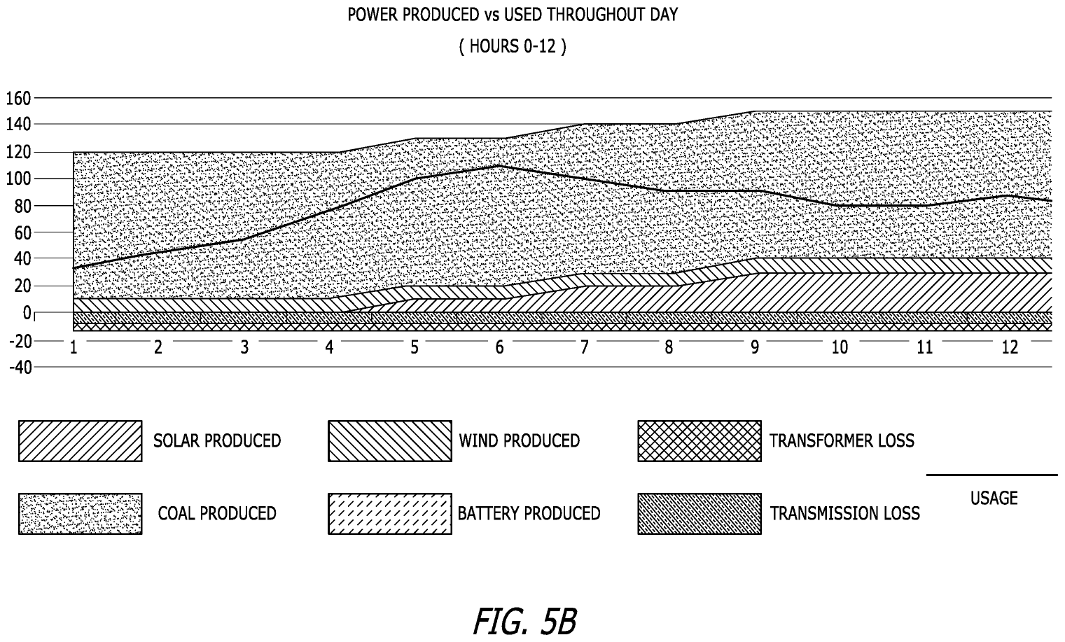

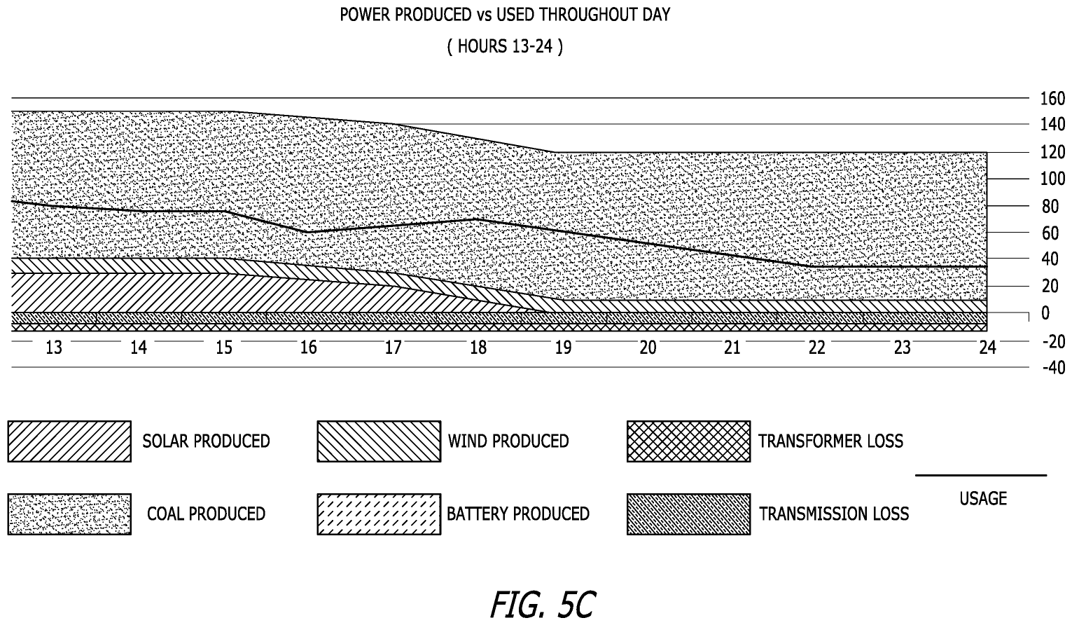

Example embodiments, thus allow for different types of power to be used at different times of the day. FIG. 5A illustrates an example graph of electric power produced throughout a given day from a variety of sources using traditional methods of power generation. FIGS. 5B-5C illustrate a close-up view of the two halves of the graph shown in FIG. 5A. Shown in the graph depicted in FIGS. 5A-5C is a typical example of bulk electric power production through out a day with an overlay of multiple sustainable sources. FIGS. 5A-5C also show the current cost of providing this power throughout the electrical power distribution environment 200 (e.g., due to transformer loss, transmission loss, etc.). Current systems can't respond to minute-to-minute fluctuations in production of renewable energy overlaid with minute-to-minute fluctuations of power consumption with modified base load production. As such, there is significant excess power generation, and renewable sources do not offset power production from legacy power generation facilities.

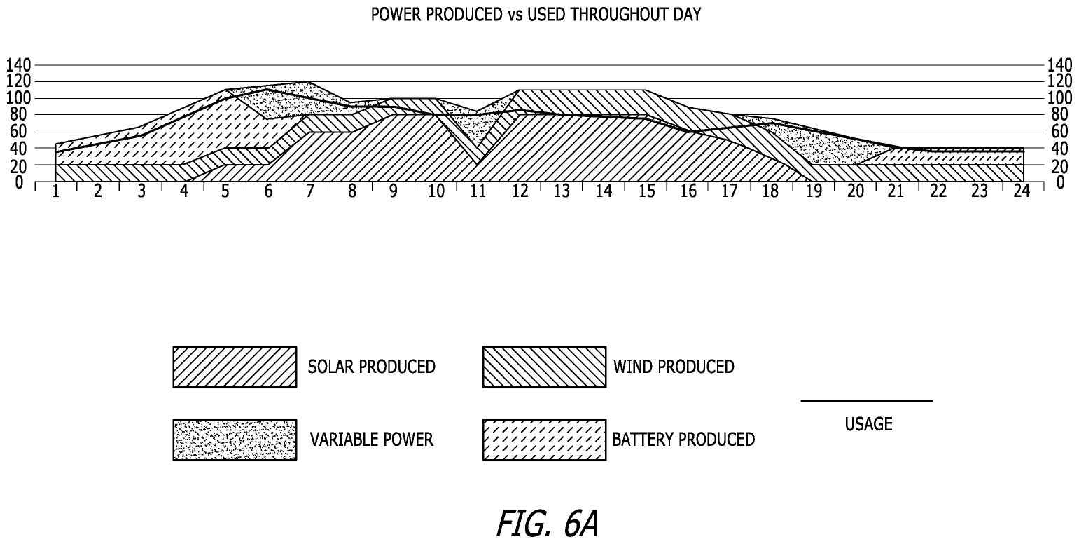

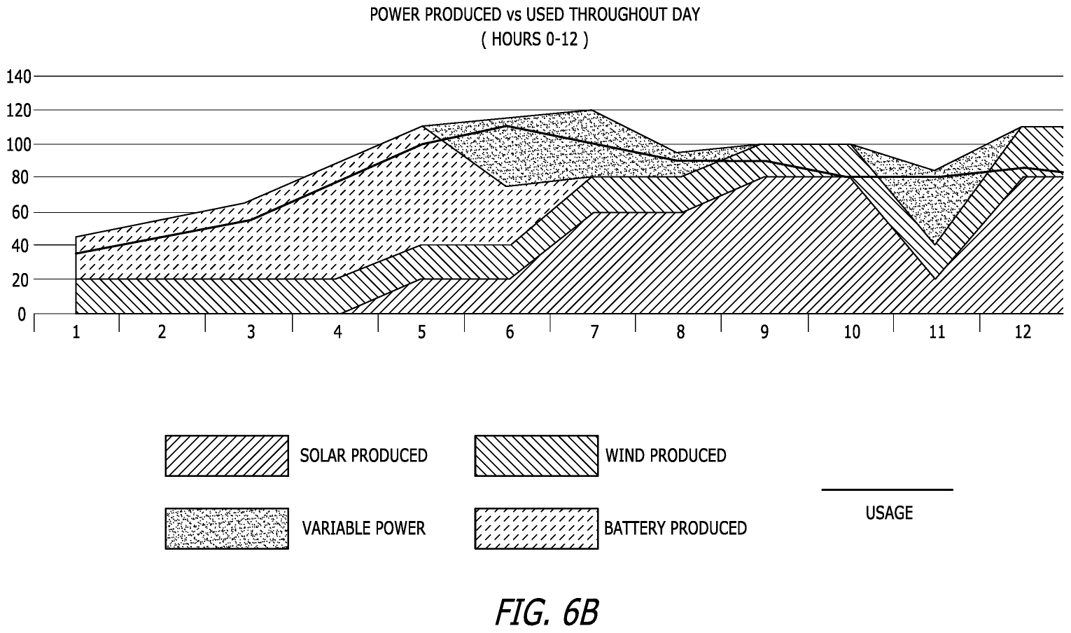

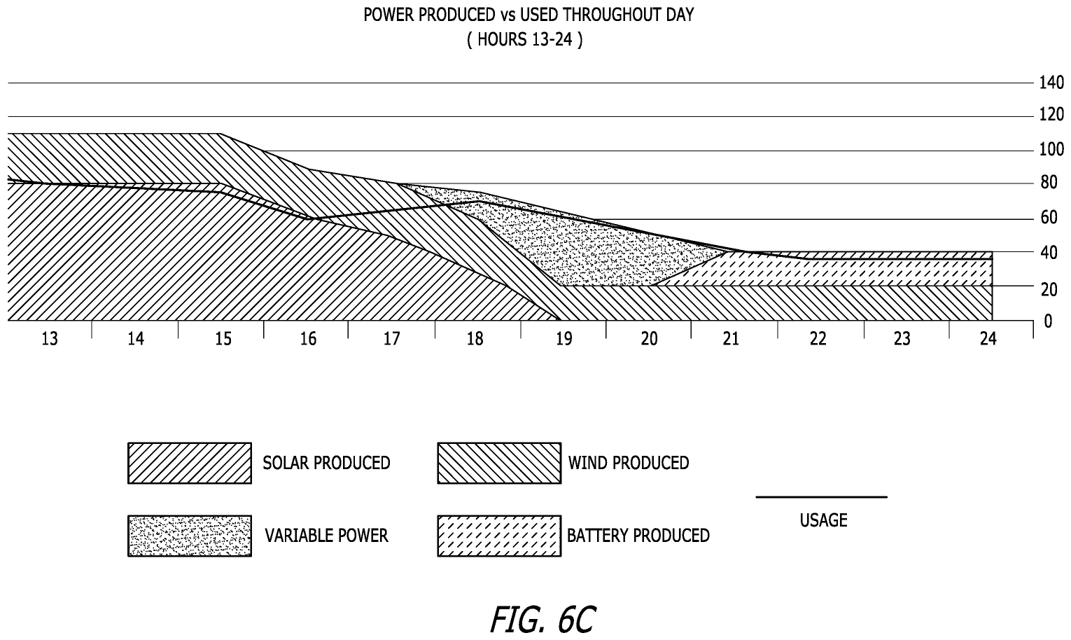

FIG. 6A illustrates a simulation of electric power produced throughout a given day from a variety of sources using example embodiments described herein for differential power generation. FIGS. 6B-6C illustrate a close-up view of the two halves of the graph shown in FIG. 6A. The simulation shown in FIGS. 6A-6C illustrate a combination of battery power and wind generation being used before the sun comes up, moving to a variable power production overlay during the peak of the day. As shown in this example, solar generated through the sunny times is used for power production, while excess wind generation is used to recharge battery storage. On this particular day, the sun reduces at hour eleven, showing that variable power can be engaged to react to minute-to-minute fluctuations in renewable energy generation. The control system 230 may further cause the system to capture unused power at the substation to charge a battery cluster team pack for use during transmission line faults or failures.

Using the enhanced infrastructure described herein, example embodiments allow for flexibility in power production. For instance, some embodiments may preferentially replace fossil fuel (primary diesel) with a green diesel equivalent as production increases, and as power production facilities using fossil-based diesel are repurposed with green diesel, priority calculations adjust. Example embodiments also minimize the excess power produced because the need for power is known from second-to-second, so the control system 230 can take full advantage of microgrid power production with limited loss from transmission and multiple transformers.

Although a high level explanation of the operations of example embodiments has been provided above, specific details regarding the configuration of such example embodiments are provided below.

### Definition of Certain Terms

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly describe herein are also contemplated as may be set forth in some of the appended claims. Although specific terms are employed herein, they are used in a generic and descriptive sense only and not for purposes of limitation.

The terms “data,” “content,” “information,” “electronic information,” “signal,” “command,” and similar terms may be used interchangeably to refer to data capable of being transmitted, received, and/or stored in accordance with embodiments of the present invention. Thus, use of any such terms should not be taken to limit the spirit or scope of embodiments of the present invention. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

The terms “comprising” means including but not limited to, and should be interpreted in the manner it is typically used in the patent context. Use of broader terms such as comprises, includes, and having should be understood to provide support for narrower terms such as consisting of, consisting essentially of, and comprised substantially of.

The terms “in one embodiment,” “according to one embodiment,” “in some embodiments,” and the like generally may refer to the fact that the particular feature, structure, or characteristic following the phrase may be included in at least one embodiment of the present invention. Thus, the particular feature, structure, or characteristic may be included in more than one embodiment of the present invention such that these phrases do not necessarily refer to the same embodiment.

The term “example” is used herein to mean “serving as an example, instance, or illustration.” Any implementation described herein as “example” is not necessarily to be construed as preferred or advantageous over other implementations.

The terms “computer-readable medium” and “memory” refer to non-transitory storage hardware, non-transitory storage device or non-transitory computer system memory that may store computer-executable instructions or software programs that may be accessed by a controller, a microcontroller, a computational system or a module of a computational system. A non-transitory computer-readable medium may be accessed by a computational system or a module of a computational system to retrieve and/or execute the computer-executable instructions or software programs stored on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

The term “computing device” may refer to any computer embodied in hardware, software, firmware, and/or any combination thereof. Non-limiting examples of computing devices include a personal computer, a server, a laptop, a mobile device, a smartphone, a fixed terminal, a personal digital assistant (“PDA”), a kiosk, a custom-hardware device, a wearable device, a smart home device, an Internet-of-Things (“IoT”) enabled device, and a network-linked computing device.

The term “control system” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, server devices, and similar electronic devices equipped with at least a processor and any other physical components necessary to perform the various operations described herein.

The term “fiber optic network” is used herein to refer to a communication network which includes one or more optical fiber cables, which may be used facilitate the transfer of a signal (e.g., telemetry data) between respective terminals (e.g., a starting node or optical line terminal (OLT) and a terminating node or optical network terminal (ONT)). At least a portion of each optical fiber cable may further be disposed within a cable jacket, which may serve to protect the optical fiber cable from environmental conditions and ensure long-term durability. Additionally, the cable jacket may minimize attenuation of carried signals due to microbleeding. In some embodiments, the fiber optic network is a PON. A PON may use one or more fiber optic splitters to divide individual optical fiber cables among two or more ONTs, thus reducing the number of fiber optic cables needed for connectivity and the number of active devices requiring electrical power. A PON may utilize wavelength-division multiplexing (e.g., coarse wavelength division multiplexing (CWDM) or dense wavelength division multiplexing (DWDM)) to permit bidirectional communications and/or a multiplication of capacity of the fiber optic network. In some embodiments, downstream signals provided by an OLT are received by all ONTs. In some embodiments, these downstream signals are encrypted using any suitable technique to prevent eavesdropping.

The term “telemetry data” is used here to refer to data collected by various devices within the power distribution environment and transmitted via the fiber optic network. For example, the telemetry data may be collected by smart meters at a customer premises, transformers, down-line reclosers, and distributed power generation facilities, and/or the like. Telemetry data may be transmitted via the fiber optic network in sub-millisecond intervals. In some embodiments, the telemetry data may be indicative of a real-time electrical load for the group of customer premises within the corresponding fiber optic network. In some embodiments, the telemetry data may be encrypted using an encryption key. The encryption key may be a symmetric encryption key which is shared between two or more active devices or other devices within the fiber optic network. The encryption key may correspond to a symmetric key algorithm, such as advanced encryption standard (AES), Blowfish, data encryption standard (DES), and/or the like.

### Example Implementing Apparatuses

FIG. 3 illustrates an apparatus 300 that may comprise an example control system 230 that may implement example embodiments described herein. The apparatus may include processor 302, memory 304, communications circuitry 306, and input-output circuitry 308, each of which will be described in greater detail below, along with and any number of additional hardware components not expressly shown in FIG. 3. While the various components are only illustrated in FIG. 3 as being connected with processor 302, it will be understood that the apparatus 300 may further comprises a bus (not expressly shown in FIG. 3) for passing information amongst any combination of the various components of the apparatus 300. The apparatus 300 may be configured to execute various operations described above, as well as those described below in connection with FIG. 3.

The processor 302 (and/or co-processor or any other processor assisting or otherwise associated with the processor) may be in communication with the memory 304 via a bus for passing information amongst components of the apparatus. The processor 302 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 300, remote or “cloud” processors, or any combination thereof.

The processor 302 may be configured to execute software instructions stored in the memory 304 or otherwise accessible to the processor (e.g., software instructions stored on a separate storage device). In some cases, the processor may be configured to execute hard-coded functionality. As such, whether configured by hardware or software methods, or by a combination of hardware with software, the processor 302 represent an entity (e.g., physically embodied in circuitry) capable of performing operations according to various embodiments of the present invention while configured accordingly. Alternatively, as another example, when the processor 302 is embodied as an executor of software instructions, the software instructions may specifically configure the processor 302 to perform the algorithms and/or operations described herein when the software instructions are executed.

Memory 304 is non-transitory and may include, for example, one or more volatile and/or non-volatile memories. In other words, for example, the memory 304 may be an electronic storage device (e.g., a computer readable storage medium). The memory 304 may be configured to store information, data, content, applications, software instructions, or the like, for enabling the apparatus to carry out various functions in accordance with example embodiments contemplated herein.

The communications circuitry 306 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 306 may include, for example, a network interface for enabling communications with a wired or wireless communication network. For example, the communications circuitry 306 may include one or more network interface cards, antennas, buses, switches, routers, modems, and supporting hardware and/or software, or any other device suitable for enabling communications via a network. Furthermore, the communications circuitry 306 may include the processing circuitry for causing transmission of such signals to a network or for handling receipt of signals received from a network.

The apparatus 300 may include input-output circuitry 308 configured to provide output to a user and, in some embodiments, to receive an indication of user input. It will be noted that some embodiments will not include input-output circuitry 308, in which case user input may be received via a separate device. The input-output circuitry 308 may comprise a user interface, such as a display, and may further comprise the components that govern use of the user interface, such as a web browser, mobile application, dedicated client device, or the like. In some embodiments, the input-output circuitry 308 may include a keyboard, a mouse, a touch screen, touch areas, soft keys, a microphone, a speaker, and/or other input/output mechanisms. The input-output circuitry 308 may utilize the processor 302 to control one or more functions of one or more of these user interface elements through software instructions (e.g., application software and/or system software, such as firmware) stored on a memory (e.g., memory 304) accessible to the processor 302.

In some embodiments, various components of the apparatus 300 may be hosted remotely (e.g., by one or more cloud servers) and thus not all components must reside in one physical location. Moreover, some of the functionality described herein may be provided by third party circuitry. For example, apparatus 300 may access one or more third party circuitries via any sort of networked connection that facilitates transmission of data and electronic information between the apparatus 300 and the third party circuitries. In turn, the apparatus 300 may be in remote communication with one or more of the components describe above as comprising the apparatus 300.

As will be appreciated based on this disclosure, some example embodiments may take the form of a computer program product comprising software instructions stored on at least one non-transitory computer-readable storage medium (e.g., memory 304). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 300 as described in FIG. 3, that loading the software instructions onto a computing device or apparatus produces a special-purpose machine comprising the means for implementing various functions described herein.

Having described specific components of the apparatus 300, example embodiments are described below.

### Example Operations

Turning to FIG. 4, an example flowchart is illustrated that contains example operations implemented by various embodiments contemplated herein. The operations illustrated in FIG. 4 may, for example, be performed by an apparatus 300, which is shown and described in connection with FIG. 3. To perform the operations described below, the apparatus 300 may utilize one or more of processor 302, memory 304, communications circuitry 306, input-output circuitry 308, other components, and/or any combination thereof. It will be understood that user interaction with the apparatus 300 may occur directly via input-output circuitry 308, or may instead be facilitated by a device that in turn interacts with apparatus 300.

As shown by operation 402, the apparatus 300 includes means, such as processor 302, memory 304, communications circuitry 306, input-output circuitry 308, or the like, for receiving telemetry data from a set of devices in an electrical grid. The telemetry data may be received via one or more optical fiber cables, which may be used facilitate the transfer of a signal (e.g., telemetry data) between respective terminals (e.g., a starting node or optical line terminal (OLT) such as a customer premise and a terminating node or optical network terminal (ONT) such as apparatus 300). The fiber optic network, which may be a PON. The PON may use one or more fiber optic splitters to divide individual optical fiber cables among two or more ONTs, thus reducing the number of fiber optic cables needed for connectivity and the number of active devices requiring electrical power. A PON may utilize wavelength-division multiplexing (e.g., coarse wavelength division multiplexing (CWDM) or dense wavelength division multiplexing (DWDM)) to permit bidirectional communications and/or a multiplication of capacity of the fiber optic network. In some embodiments, the telemetry data is encrypted using any suitable technique to prevent eavesdropping. The use of CWDM, DWDM, or any other multiplexing technique may permit near-real-time telemetry data to be collected from any number of devices over the fiber optic network infrastructure.

It will be appreciated that in some implementations, an alternative method of transmitting the telemetry data may be utilized besides a fiber optic network (e.g., any other Internet-based communications). The set of devices may include any entities located within the electrical power distribution environment 200, such as smart meters at customer premises, transformers, down-line reclosers, and distributed power generation facilities.

The received telemetry data may be indicative of a real-time electrical load for a group of customer premises. For example, referring back to FIG. 2, telemetry data received by control system 230 may be indicative of the real-time electrical load for the fiber optic network 240 connected to the customer premises 1 to n. As such, apparatus 300 may be able to determine the real-time electrical power usage for the customer premises 1 to n, which may receive power from the distribution network 215, also in communication with apparatus 300. The telemetry data may also be indicative of a power distribution cost (e.g., transformer loss, transmission loss, etc.) associated with distributing power to each customer premise or the group of customer premises 1 to n.

As shown by operation 404, the apparatus 300 includes means, such as processor 302, memory 304, communications circuitry 306, input-output circuitry 308, or the like, for calculating an electrical load for the electrical grid based on the telemetry data. As described above, the received telemetry data may be indicative of a real-time electrical load for a group of customer premises. In some embodiments, the telemetry data may be indicative of the real-time electrical load for each customer premise of the group of customer premises 1 to n. The apparatus 300 may perform one or more mathematical and/or logical operations on the telemetry data to calculate the electrical load for the electrical grid. For example, apparatus 300 may add each electrical load for each customer premise of the group of customer premises 1 to n as well as the associated power distribution cost (e.g., transformer loss, transmission loss, etc.) to calculate the electrical load.

The corresponding electrical grid may be connected with the group of customer premises 1 to n such that the electrical grid may supply power to each customer premise. For example, referring back to FIG. 2, the electrical grid may supply the customer premises 1 to n with power via distribution network 215.

As shown by operation 406, the apparatus 300 includes means, such as processor 302, memory 304, communications circuitry 306, input-output circuitry 308, or the like, for generating a set of power production metrics. These power production metrics may include distribution efficiency along electric lines, power from a substation, power production costs of one or more of the multiple sources of electricity, an overall power production cost for supplying the electrical grid, an environmental impact of power production from one or more of the multiple sources of electricity; or one or more maintenance-related factors relating to one or more of the multiple sources of electricity. The apparatus 300 may generate these power production metrics based on the telemetry data, or based on other data gathered by the apparatus 300. For instance, the apparatus 300 may further include means, such as processor 302, memory 304, communications circuitry 306, input-output circuitry 308, or the like, for receiving near-real-time power production data from each of the multiple sources of electricity, and generating the set of power production metrics based on the near-real-time power production data.

In some embodiments, the distribution efficiency along electric lines for a particular power source may be indicative of the power distribution cost (e.g., transmission loss, transformer loss, etc.) associated with generating electricity at a particular power source and providing the electricity to a group of customer premises. As such, power sources which are located remotely from the customer premises may be associated with a lower distribution efficiency than power sources which are geographically closer to the customer premises.

In some embodiments, the power from a substation may be indicative of power specifications (e.g., a minimum, maximum, etc.) for a substation within the corresponding electrical grid. In some embodiments, a substation may be configured with one or more batteries, such that the substation may provide power to the customer premises and/or may store excess power. The power metrics may therefore also indicate whether a substation is configured with batteries, the status of each battery (e.g., full, charging, empty, etc.), an electrical storage load capacity for the substation, etc.

In some embodiments, the power production costs of one or more of the multiple sources of electricity may be indicative of the associated cost of producing electrical power at the power source. The power production cost may be based on an associated cost to operate the facility to produce power for the particular power source. For example, a solar produced power source may have a low power production cost as corresponding solar cells may operate independently and automatically to produce electricity. As another example, a coal produced power source may have a high power production cost as a corresponding facility may require electrical power to operate machinery necessary to produce the coal produced power and also have associated labor costs to facilitate manual operation of the machinery.

In some embodiments, the overall power production cost for supplying the electrical grid may be indicative of the aggregated costs of producing electrical power at each power source of the multiple power sources. The overall power production cost may therefore be used to view an overall cost associated with the electrical grid.

In some embodiments, the environmental impact of power production from one or more of the multiple sources of electricity may be indicative of an associated environmental impact associated with using a particular power source. The environmental impact may be indicative of how positive or negative the operation of a particular power source is on the surrounding environment. For example, a solar produced power source may have a low environmental impact as solar energy is renewable and has a low pollution impact on the environment. As another example, a coal produced power source may have a high environmental impact as coal is a nonrenewable energy source and is associated with a high pollution impact on the environment.

In some embodiments, the one or more maintenance-related factors relating to one or more of the multiple sources of electricity may be indicative of an associated maintenance cost for each power source. An associated maintenance cost may be based on equipment costs, labor costs, resource costs, etc.

In some embodiments, the apparatus 300 may use a source production cost model to generate the set of power production metrics. In some embodiments, the source production cost model may be a machine learning model configured to determine power production metrics for each source of the multiple sources of electricity based on the calculated electrical load. The source production cost model may be a neural network, such as a long short-term memory (LSTM) neural network. In some embodiments, the source production cost model may be a model which uses deep learning techniques to generate the power production metrics. In particular, the source production cost model may be configured to receive the calculated electrical load as input. In some embodiments, the source production cost model may also receive or otherwise access other data, such as supplementary data. Supplementary data may include current weather data, power source status (e.g., online or offline) for a particular power source, etc. The source production cost model may then process the electrical load input and supplementary factors to determine power production metrics for each source of the multiple power sources.

For example, the source production cost model may determine power production metrics for each of a solar power source and a battery power source. If the current weather data indicates sunny weather, the source production cost model may then determine a low overall power production cost for supplying the electrical grid for the solar power source. Alternatively, if the current weather data indicates rainy weather with high winds, the source production cost model may then determine a low overall power production cost for supplying the electrical grid for the wind power source.

As shown by operation 408, the apparatus 300 includes means, such as processor 302, memory 304, communications circuitry 306, input-output circuitry 308, or the like, for identifying based on the calculated electrical load for the electrical grid and the set of power production metrics, an optimal allocation of power production from multiple sources of electricity that supply the electrical grid. In particular, apparatus 300 may identify the optimal allocation of power production by comparing the electrical load for the given electrical grid to the power production cost as described by the set of power production metrics. Apparatus 300 may determine to allocate a power production to power sources which are associated with a low environmental impact and power production cost over other power sources. Comparing electrical load to power production cost, allows microgrid electricity source adjustments to the lowest power production cost and least environmental impact.

Furthermore, apparatus 300 may allocate a set power supply amount to each power source such that the electrical grid is supplied with the appropriate amount and minimize an excess power supplied. As such, this optimal allocation also saves on costs associated with producing the electrical power supplied to the electrical grid.

Finally, as shown by operation 410, the apparatus 300 includes means, such as processor 302, memory 304, communications circuitry 306, input-output circuitry 308, or the like, for causing, based on the optimal allocation of power production from the multiple sources of electricity, adjustment to power production from one or more of the multiple sources of electricity. This adjustment may involve capturing unused power at a substation to charge one or more batteries (e.g., a battery enclave that may be used at other times of the day) which is electrically coupled to the substation.

It will be appreciated that operations 402-410 may be repeated frequently and/or periodically. For instance, the apparatus 300 may receive new telemetry data from the set of devices in as little as a sub-millisecond interval following initial receipt of telemetry data from the set of devices. Moreover, new telemetry data may be received periodically at predefined intervals, which may be sub-millisecond or longer intervals. This new telemetry data may be used to calculate a revised electrical load for the electrical grid based, generate a revised set of power production metrics for the multiple sources of electricity that supply the electrical grid, identify a revised optimal allocation of power production based on the revised electrical load and the revise set of power metrics, and cause adjustment to power production based on the revised optimal allocation.

In addition, although operation 410 describes causing adjustment to power production, this may not occur every time operations 402-408 are performed. For instance, the apparatus 300 may include means, such as processor 302, memory 304, communications circuitry 306, input-output circuitry 308, or the like, for determining whether the optimal allocation of power production from the multiple sources of electricity sufficiently deviates from a current allocation of power production from the multiple sources. The apparatus 300 may cause adjustment to the power production from the one or more of the multiple sources of electricity only in response to determining that that the optimal allocation of power production from the multiple sources of electricity sufficiently deviates from the current allocation of power production from the multiple sources.

FIG. 4 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for differential power generation, the method comprising:
receiving, by a control system, telemetry data from a set of devices in an electrical grid;
calculating, by the control system, an electrical load for the electrical grid based on the telemetry data;
generating, by the control system, a set of power production metrics;
identifying, by the control system and based on the calculated electrical load for the electrical grid and the set of power production metrics, an optimal allocation of power production from multiple sources of electricity that supply the electrical grid; and
causing, by the control system and based on the optimal allocation of power production from the multiple sources of electricity, adjustment to power production from one or more of the multiple sources of electricity.

2. The method of claim 1, wherein the telemetry data is received via a fiber optic network.

3. The method of claim 2, wherein the telemetry data is received via passive-optical networking.

4. The method of claim 1, wherein the set of devices comprise smart meters at customer premises, transformers, down-line reclosers, and distributed power generation facilities.

5. The method of claim 1, wherein the set of power production metrics includes one or more of:
distribution efficiency along electric lines;
power from a substation;
a power production cost of one or more of the multiple sources of electricity;
an overall power production cost for supplying the electrical grid;
an environmental impact of power production from one or more of the multiple sources of electricity; or
one or more maintenance-related factors relating to one or more of the multiple sources of electricity.

6. The method of claim 1, further comprising:
receiving, by the control system, near-real-time power production data from each of the multiple sources of electricity,
wherein generating the set of power production metrics is based on the near-real-time power production data.

7. The method of claim 1, further comprising:
capturing unused power at a substation to charge one or more batteries electrically coupled to the substation.

8. The method of claim 1, further comprising:
receiving, by the control system, new telemetry data from the set of devices;
calculating, by the control system, a revised electrical load for the electrical grid based on the new telemetry data;
generating, by the control system, a revised set of power production metrics for multiple sources of electricity that supply the electrical grid;
identifying, by the control system and based on the revised electrical load for the electrical grid and the revised set of power production metrics, a revised optimal allocation of power production from the multiple sources of electricity; and
causing, by the control system and based on the revised optimal allocation of power production from the multiple sources of electricity, adjustment to power production from one or more of the multiple sources of electricity.

9. The method of claim 8, wherein the control system receives the new telemetry data from the set of devices a sub-millisecond interval after receiving the telemetry data.

10. The method of claim 8, wherein the control system periodically receives additional telemetry data from the set of devices, and wherein the control system causes adjustment to the power production from one or more of the multiple sources of electricity each time additional telemetry data is received from the set of devices.

11. The method of claim 1, further comprising:
determining, by the control system, that the optimal allocation of power production from the multiple sources of electricity sufficiently deviates from a current allocation of power production from the multiple sources,
wherein the control system causes the adjustment to the power production from the one or more of the multiple sources of electricity in response to determining that that the optimal allocation of power production from the multiple sources of electricity sufficiently deviates from the current allocation of power production from the multiple sources.

12. An apparatus for differential power generation, the apparatus comprising a processor and a memory storing software instructions that, when executed by the processor, cause the apparatus to:
receive telemetry data from a set of devices in an electrical grid;
calculate an electrical load for the electrical grid based on the telemetry data;
generate a set of power production metrics;
identify, based on the calculated electrical load for the electrical grid and the set of power production metrics, an optimal allocation of power production from multiple sources of electricity that supply the electrical grid; and
cause, based on the optimal allocation of power production from the multiple sources of electricity, adjustment to power production from one or more of the multiple sources of electricity.

13. The apparatus of claim 12, wherein the telemetry data is received via a fiber optic network.

14. The apparatus of claim 13, wherein the telemetry data is received via passive-optical networking.

15. The apparatus of claim 12, wherein the set of devices comprise smart meters at customer premises, transformers, down-line reclosers, and distributed power generation facilities.

16. The apparatus of claim 12, wherein the set of power production metrics includes one or more of:
distribution efficiency along electric lines;
power from a substation;
a power production cost of one or more of the multiple sources of electricity;
an overall power production cost for supplying the electrical grid;
an environmental impact of power production from one or more of the multiple sources of electricity; or
one or more maintenance-related factors relating to one or more of the multiple sources of electricity.

17. The apparatus of claim 12, the processor and a memory storing software instructions that, when executed by the processor, further cause the apparatus to:
receive near-real-time power production data from each of the multiple sources of electricity,
wherein generating the set of power production metrics is based on the near-real-time power production data.

18. The apparatus of claim 12, the processor and the memory storing software instructions that, when executed by the processor, further cause the apparatus to:
capture unused power at a substation to charge one or more batteries electrically coupled to the substation.

19. The apparatus of claim 12, wherein the processor and a memory storing software instructions that, when executed by the processor, further cause the apparatus to:
receive new telemetry data from the set of devices;
calculate a revised electrical load for the electrical grid based on the new telemetry data;
generate a revised set of power production metrics for multiple sources of electricity that supply the electrical grid;
identify, based on the revised electrical load for the electrical grid and the revised set of power production metrics, a revised optimal allocation of power production from the multiple sources of electricity; and
cause, based on the revised optimal allocation of power production from the multiple sources of electricity, adjustment to power production from one or more of the multiple sources of electricity.

20. A computer program product for differential power generation, the computer program product comprising at least one non-transitory computer-readable storage medium storing software instructions that, when executed by an apparatus, cause the apparatus to:
receive telemetry data from a set of devices in an electrical grid;
calculate an electrical load for the electrical grid based on the telemetry data;
generate a set of power production metrics;
identify, based on the calculated electrical load for the electrical grid and the set of power production metrics, an optimal allocation of power production from multiple sources of electricity that supply the electrical grid; and
cause, based on the optimal allocation of power production from the multiple sources of electricity, adjustment to power production from one or more of the multiple sources of electricity.
